(19) United States
(12) Patent Application Publication
(10) Pub. No.: US 2006/0034452 A1
(43) Pub. Date: Feb. 16, 2006

(54) Code calculating device

(75) Inventors: Motonobu Tonomura, Kodaira (JP); Yuki Kondoh, Kokubunji (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 10/518,481

(22) PCT Filed: Jun. 20, 2002
(86) PCT No.: PCT/JP02/06166

§ 371 Date: Dec. 20, 2004

(51) Int. Cl. H04L 9/00

(52) U.S. Cl. 380/28

(57) ABSTRACT

A code computing apparatus with an error detection code (CRC) generating function and an elliptic curve cryptography (ECC) function, comprising a matrix element computation part 30 for generating matrix elements from parameter values set in first and second registers 201 and 202, a matrix element register 51 for holding the matrix elements generated by the matrix element computation part, and an inner product calculation part 40 for executing inner product calculation between the matrix elements held by the matrix element register and data set in a third register. The matrix element computation part selectively generates matrix elements for error detection and matrix elements for encryption by changing the parameters to be set in the first and second registers, and the inner product calculation part is shared to error control code generation and data encryption by altering the matrix elements to be held in the matrix element register.

### TECHNICAL FIELD

The present invention relates to code calculating device (a code computing apparatus) for communication data, and more particularly to code calculating device (a code computing apparatus) for generating an error detection (correction) code and data encryption/decryption processing necessary for transmitting and receiving of digital packet data.

### BACKGROUND ART

A digital communication apparatus needs an encryption/decryption function and an error detection (correction) code generating function of packet data to cope with holding data security and occurrence of a signal error on a network. As the communication need for still images or moving images having a large amount of information is increased in addition to voice data and text data communication, an encryption/decryption technique and an error detection (correction) code generating technique suitable for making the data transfer rate high are required for the digital communication apparatus.

As an error detection code of a data packet, for instance, CRC (Cyclic Redundancy Check Codes) only for error detection without performing error correction is often used. CRC computing equations are described in Ramabadran, T. V. and Gaitonde S. S. “A Tutorial on CRC Computations”, IEEE Micro, vol. 8, No. 4, pp. 62-75, August 1988.

As an encryption method used for holding data security, RSA (public-key) cryptography is well-known. The RSA, however, needs a long code with 1024 bits as an encryption/decryption key, and attention has been focused in recent years on elliptic curve cryptography (ECC) which requires a short code length of about 160 bits. With respect to the elliptic curve cryptography processing, there exists a document of Moon, S., Park, J. and Lee, Y., “Fast VLSI Arithmetic Algorithms for High-Security Elliptic Curve Cryptographic Applications” IEEE Transaction Consumer Electronics, vol. 47, No. 3, pp. 700-708, August 2001. The above document describes examples of computing equations necessary for the elliptic curve cryptography (ECC) and a large-scale integrated circuit realizing the ECC processing.

Since the RSA employs modulo arithmetic causing propagation of a carry bit, it increases the quantity of hardware. As will be described hereinafter, according to the ECC, data encryption/decryption can be realized with compact hardware because ECC is based on Galois field (finite field) which does not cause the propagation of a carry bit.

The modulo arithmetic using polynomial g(x) of degree n over Galois field shown by equation (1) will be considered.
g(x)=xⁿ+gₙ₋₁xⁿ⁻¹+ . . . +g₁x+1 (1)

This Galois field of the polynomial is generally expressed as GF (2ⁿ). The value of coefficient gᵢ is “0” or “1” and is expressed as gᵢεGF (2). Although exclusive OR (EOR) calculation (⊕) is performed in the coefficient term of GF(2), an operator (+) is used in this specification instead of ⊕ unless it gets confused especially.

The following three polynomials expressing data having length n will be considered now, where aᵢ, bᵢ, cᵢεGF(2).

$$a ( x ) = {\sum }_{i = 1}^{n - 1} {a}_{i} {x}^{i} , \\ b ( x ) = {\sum }_{i = 0}^{n - 1} {b}_{i} {x}^{i}$$

$$c ( x ) = {\sum }_{i = 0}^{n - 1} {c}_{i} {x}^{i}$$

For the ECC, data indicating an encryption key called a public-key or a private-key is expressed with a polynomial a(x) and transmitting/receiving data to which the encryption key is applied is expressed with a polynomial b(x). In this case, encrypted data on the transmission side or decrypted data (the original unencrypted plain data) on the receiving side is obtained as calculation result c(x) of the following equation (2).
C(x)≡a(x)·b(x) mod g(x) (2)

Expressing the equation (2) in detail, the following equation (3) is given.

$${\sum }_{i = 0}^{n - 1} {c}_{i} {x}^{i} ≡ ( {\sum }_{i = 0}^{n - 1} {a}_{i} {x}^{i} ) ( {\sum }_{i = 0}^{n - 1} {b}_{i} {x}^{i} ) mod g ( x ) \qquad ( 3 )$$

In documents: Mastrovito, E. D., “VLSI Designs for Multiplication over Finite Fields GF(2^{m})”, Proc. Sixth Int'l Conf. “Applied Algebra, Algebraic Algorithms, and Error-Correcting Codes (AAECC-6)” pp. 297-309, July 1988, and WO 91/20028 (Title of the Invention: “Universal Galois Field Multiplier”), Mastrovito attempts to convert the equation (3) to the following matrix forms.

$$\begin{matrix}[ \begin{matrix}{c}_{0} \\ {c}_{1} \\ . \\ . \\ {c}_{n - 1}\end{matrix} ] = [ \begin{matrix}{m}_{00} & {m}_{01} … & {m}_{0 , n - 1} \\ {m}_{10} & {m}_{11} … & {m}_{1 , n - 1} \\ . & . & . \\ . & . & . \\ {m}_{n - 1 , 0} & {m}_{n - 1 , 1} & {m}_{n - 1 , n - 1}\end{matrix} ] [ \begin{matrix}{b}_{0} \\ {b}_{1} \\ . \\ . \\ {b}_{n - 1}\end{matrix} ] & ( 4 ) \\ C = M \cdot b & ( 5 )\end{matrix}$$

A matrix M of n×n in the equation (4) is called a Mastrovito matrix. The elements of the matrix M can be previously calculated from the polynomials a(x) and g(x).

On the other hand, the value of CRC is calculated as the remainder c(x) obtained when xⁿ·b(x) is divided by the polynomial g(x), as shown by the following equation (6), in the case where data of a transmitting message (or receiving message) is expressed by the polynomial b(x).
c(x)=xⁿ·b(x) mod g(x) (6)
where xⁿ·b(x) means that the data b(x) is shifted to the left by n bits. The data transmission side sends out, to the transmission path, transmitting data b(x) to which the polynomial c(x) indicating the value of CRC calculated by the equation (6) is added.

The data receiving side performs the same calculation to the received data b(x) with CRC and judges that the received data b(x) has no errors with a very high probability when the calculation result c(x) is 0.

Comparing the equation (2) with the equation (6), the computing equations of CRC and ECC are found to be very similar. The difference lies in that the value, by which the data b(x) is multiplied, is xⁿ of degree n for CRC, but it is the polynomial a(x) of degree n−1 for ECC.

The above documents describing the Mastrovito matrix seem to generally treat an error correction method called BCH or Reed-Solomon by the equation (2). However, the above documents do not specifically describe how these encryption methods are concretely related with the equation (2). The above documents do not suggest the later-described CRC code matrix expression noted by the present invention.

### DISCLOSURE OF THE INVENTION

An object of the present invention is to provide a code computing apparatus applicable to both of error detection and data encryption/decryption.

Another object of the present invention is to provide a Galois field (finite field) code computing apparatus applicable commonly to error detection and data encryption/decryption.

A further object of the present invention is to provide a code computing apparatus capable of calculating matrix elements for error detection and data encryption/decryption by the same matrix element computation part and selectively uses these matrix elements to error detection and data encryption/decryption.

A furthermore object of the present invention is to provide a packet communication apparatus capable of performing error detection and data encryption/decryption with a compact hardware configuration.

In order to achieve these objects, the present invention is characterized by the hardware applicable in common to CRC computation and ECC computation, which is proposed based on the similarity between Galois field-based CRC and ECC computing equations.

According to one of solving methods which can be easily considered in order to share the computing processing between CRC and ECC, the degree of the polynomial a(x) by which the data b(x) is multiplied in ECC computation shown by the equation (2) is increased from degree n−1 to degree n so as to be consistent with the degree of xⁿ in the CRC computation shown by the equation (6), and when performing the CRC computation, the coefficient part of degree n of the polynomial a(x) is used. However, such a method that increases the degree of the polynomial a(x) cannot be an essential solving method.

The present invention uses the following characteristic of modulo arithmetic over Galois field to share the computing processing between CRC and ECC.

As shown by the equation (1), coefficient gₙ of xⁿ of the irreducible polynomial g(x) applied to the module arithmetic over Galois field is “1”. When the higher degree term xⁿ higher than the degree n to be applied to the CRC computation shown by the equation (6) is subject to modulo arithmetic by g(x) for reduction to the term of the remainder below degree n-1, the following polynomial (7) is obtained.
Xⁿ mod g(x)≡gₙ₋₁xⁿ⁻¹+ . . . g₁x+1 (7)

Here, the right side of the equation (7) is replaced with the following equation.
g′(x)=gₙ₋₁xⁿ⁻¹+ . . . g₁x+1 (8)

The CRC computing equation shown by the equation (6) is transformed to the following equation (9). Like the ECC computing equation (2), the degree of the polynomial by which the data b(x) is multiplied can be reduced to degree n-1.
c(x)≡g′(x)·b(x) mod g(x) (9)

The value of CRC can be calculated according to the equation (9) by setting the value of g′(x) in place of a(x).

Further, when term xⁿ⁺¹ of higher degree than xⁿ is subject to modulo arithmetic by g(x), it is found that reduction of it to the term below degree n−1 can be done using the equation (7), as shown by the following equation (10).

$$\begin{matrix}{X}^{n + 1} mod g ( x ) ≡ {g}_{n - 1} {x}^{n} + {g}_{n - 2} {x}^{n - 1} + … + {g}_{1} {x}^{2} + x \\ = {g}_{n - 1} ( {g}_{n - 1} {x}^{n - 1} + … + {g}_{1} x + 1 ) + \\ {g}_{n - 2} {x}^{n - 1} + … + {g}_{1} {x}^{2} + x \\ = ( {g}_{n - 1} {g}_{n - 1} + {g}_{n - 2} ) {x}^{n - 1} + \\ ( {g}_{n - 1} {g}_{n - 2} + {g}_{n - 3} ) {x}^{n - 2} + … + \\ ( {g}_{n - 1} {g}_{2} + {g}_{1} ) {x}^{2} + ( {g}_{n - 1} {g}_{1} + 1 ) x + {g}_{n - 1}\end{matrix} \qquad ( 10 )$$

Accordingly, by comparing the coefficient terms of xⁱ, after subjecting the term of degree higher than degree n to reduction to the term below degree n−1, it is able to obtain the matrix elements of the equation (4) or (5).

One feature of the present invention resides in that the CRC computing equation is transformed like the equation (9), the degree is adapted to the ECC computing equation (3), and the same matrix element computation part is used to compute the elements of ECC matrix and CRC matrix. Another feature of the present invention resides in that ECC encryption/decryption computation and CRC computation are executed by the same inner product calculation part, by selectively using ECC matrix elements and CRC matrix elements calculated previously.

### BRIEF DESCRIPTION OF THE DRAWINGS

FIG. 1 is a block diagram showing the configuration of a packet communication apparatus having an error detection function and an encryption function to which the present invention is applied;

FIG. 2 is a diagram for explaining data encryption and decryption of CRC error detection;

FIG. 3 is a diagram for explaining data encryption and decryption of ECC;

FIG. 4 is a block diagram of a computing apparatus having a matrix element computation circuit 30 showing an embodiment of the present invention;

FIG. 5 is a diagram for explaining an array of the calculated elements of a matrix M generated by the matrix element computation circuit 30;

FIG. 6 is an explanatory view when generating the calculated elements of a matrix M of n×n divided into a plurality of submatrices;

FIG. 7 is a diagram for explaining the relation between submatrices constituting a matrix M for ECC and input/output data;

FIG. 8 is a diagram showing an embodiment of the matrix element computation part 30 shared between CRC and ECC;

FIG. 9 is a flowchart showing an embodiment of a CRC matrix element generation routine 100 to be executed by a controller 70 shown in FIG. 4;

FIG. 10 is a flowchart showing an embodiment of an ECC matrix element generation routine 120 to be executed by the controller 70;

FIG. 11 is a flowchart showing a transmitting data processing routine 200 and a receiving data processing routine 300 to be executed by the controller 70;

FIG. 12 is a flowchart showing the detail of transmitting data encryption 210 in the transmitting data processing routine 200; and

FIG. 13 is a flowchart showing the detail of CRC generation 230 in the transmitting data processing routine 200.

### BEST MODE FOR CARRYING OUT THE INVENTION

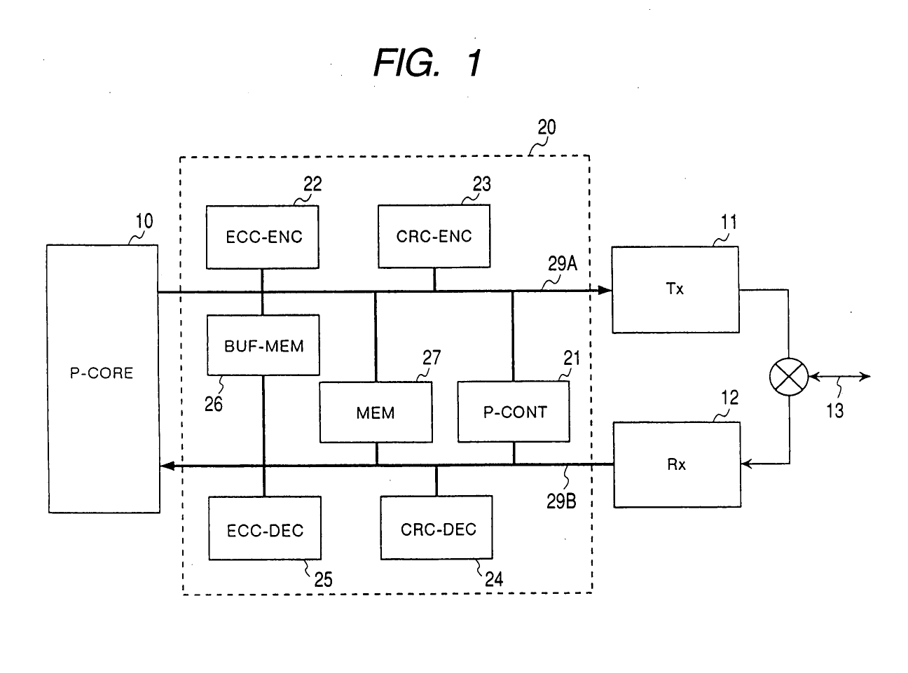

FIG. 1 shows a block diagram of a packet communication apparatus having a data error detection function and an encryption function to which the present invention is applied.

The packet communication apparatus is comprised of a core processor (P-CORE) 10, a processing part 20 for processing transmitting and receiving data, and a transmission part 11 and a receiving part 12 connected to a transmission path 13. The transmission part 11 and the receiving part 12 include an A/D converter, D/A converter and an RF (radio frequency) processing part in the case where the transmission path 130 is wireless. The transmission part 11 and the receiving part 12 include a modem processing part in the case where the transmission path 13 is an analog cable.

The processing part 20 for processing transmitting and receiving data is comprised of a control processor (P-CONT) 21, an encryption processing part (ECC-ENC) 22, an error detection code encoding part (CRC-ENC) 23, an error detection code decoding part (CRC-DEC) 24, a decryption processing part (ECC-DEC) 25, a buffer memory (BUF-MEM) 26, and a memory (MEM) 27. These elements are connected to each other through an internal bus 29 (29A and 29B).

A transmitting message (plain data) outputted from the core processor 10 is temporarily stored in a transmission buffer area of the buffer memory 26. When the transmitting data must hold data security, the transmitting message is encrypted by the encryption processing part 22. The transmitting message (plain data or encrypted data), added with an error detection code generated by the error detection code encoding part 23, is transmitted from the transmission part 11 to the transmission path 13.

A receiving message (plain data or encrypted data) with an error detection code received from the transmission path 13 is once stored in a receiving buffer area of the buffer memory 26 from the receiving part 12. The error detection code decoding part 24 performs remainder computation of the error detection code of the receiving message. If the remainder is zero, it is judged that the received data has no errors and the error detection code is removed from the receiving message. When the data of the receiving message from which the error detection code has been removed is encrypted data, it is restored to the plain data by the decryption processing part 25. After that, the receiving message is transferred via the buffer memory 26 to the core processor 10. Information necessary for error detection and data encryption/decryption is read out from the memory 27. The encryption processing part 22, the error detection code encoding part 23, the error detection code decoding part 24, and the decryption processing part 25 are controlled by the control processor 21.

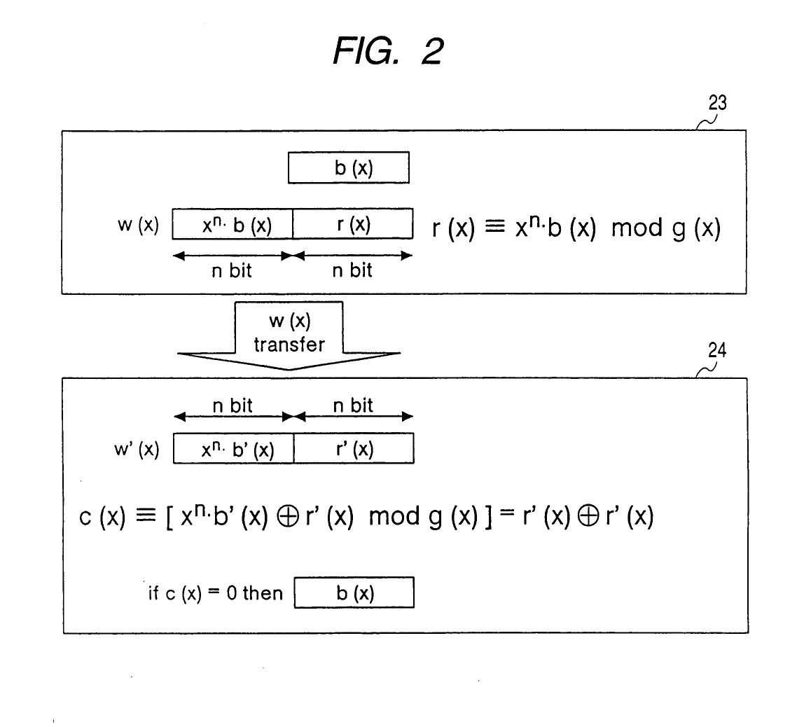

FIG. 2 shows the operations of the error detection code encoding part 23 and the error detection code decoding part 24 in the case where CRC is applied to error detection.

In this case, the error detection code encoding part 23 divides transmitting data into data blocks b(x) having an n-bit length (n=32 bits) to perform encryption for each of the data blocks. As shown by the equation (6), the data b(x) is shifted to the left by n bits (computation of xⁿ·b(x)). Then the data is divided by a specified numerical value g(x) (modulo arithmetic) to determine a remainder r(x).
r(x)≡xⁿ·b(x) mod g(x) (11)

The r(x) is added to the data xⁿ·b(x), that is, the computation of w(x)=xⁿ·b(x)⊕r(x) is performed. As a result, the original n-bit data block is transmitted to the transmission path in a form converted to a data block w(x) having a 2n-bit length.

On the other hand, the error detection code decoding part 24 on the receiving side executes modulo arithmetic with the same numerical value g(x) as that of the transmission side to the data block w′(x)=xⁿ·b′(x)⊕r′(x) received from the transmission path to determine a remainder. When no errors occur on the transmission path, the following equation (12) is satisfied and the remainder c(x) becomes zero.

$$\begin{matrix}c ( x ) ≡ [ {x}^{n} \cdot {b}^{′} ( x ) ⊕ {r}^{′} ( x ) mod g ( x ) ] \\ = {r}^{′} ( x ) ⊕ {r}^{′} ( x )\end{matrix} \qquad ( 12 )$$

In this case, by removing r′(x) from the receiving data w′(x) and shifting the receiving data to the right by n bits, the original data block b(x)=b′(x) is restored. When the length of a message received from the transmission path is longer than 2n bits, the above-described error detection code decoding processing is repeated for each data block having a 2n-bit length.

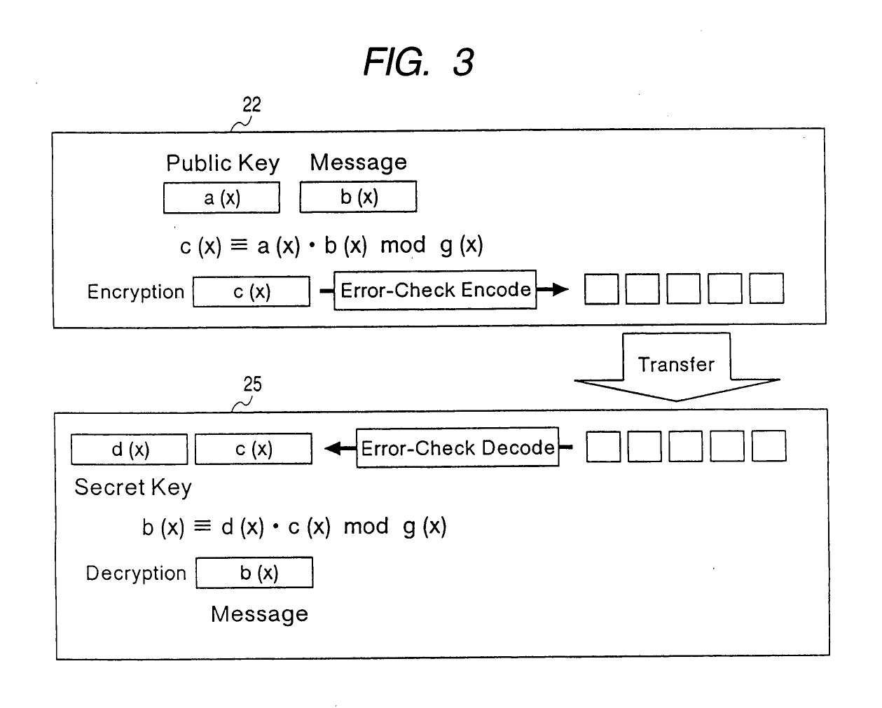

FIG. 3 shows the operations of the encryption processing part 22 and the decryption processing part 25 in the case where ECC is applied to encryption.

The encryption processing part 22 divides transmitting data into n-bit data blocks. By applying the transmitting data blocks to the polynomial b(x) and a public-key to the polynomial a(x), the modulo arithmetic is executed according to the irreducible polynomial g(x), thereby to generate the encrypted data c(x) shown by the equation (2).

The block length n of ECC encrypted data is about 160 bits which is longer than that of CRC. In order to apply the same hardware as CRC, the transmitting data block b(x), public-key a(x) and irreducible polynomial g(x) are divided into a plurality of sub-blocks each corresponding to the CRC bit length, and the encryption processing is repeated.

The encrypted data added with an error detection code is processed at the receiving side to detect an error. When the receiving data has no errors, it is restored to the encrypted data c(x) from which the error detection code has been removed. As shown by the following equation (13), the decryption processing part 25 on the receiving side applies a private-key d(x) and the receiving data c(x) in place of a(x) and b(x) of the equation (2) and executes the modulo arithmetic according to the irreducible polynomial g(x) to obtain the decrypted data b(x).
b(x)≡d(x)·c(x) mod g(x) (13)

The feature of the present invention resides in that the configuration of the processing part 20 for transmitting and receiving data is simplified by sharing hardware necessary for the error detection code encoding part 23, the error detection code decoding part 24, the encryption processing part 22, and the decryption processing part 25.

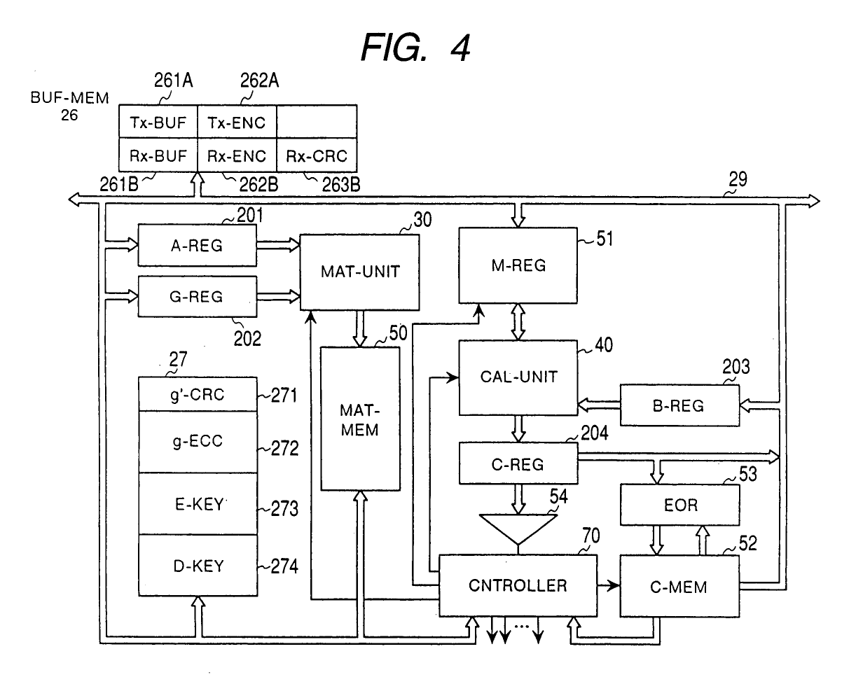

FIG. 4 shows an embodiment of the processing part 20 for processing transmitting and receiving data according to the present invention.

The processing part (code computing apparatus) 20 is comprised of a matrix element computation part (MAT-UNIT) 30, an inner product calculation part (CAL-UNIT) 40, a control part (CONTROLLER) 70, the buffer memory (BUF-MEM) 26, the memory 27 for storing parameters, a memory (MAT-MEM) 50 for storing matrix elements, a matrix element register (M-REG) 51, a calculation result holding memory (C-MEM) 52, parameter registers (A-REG and G-REG) 201 and 202, a data register (B-REG) 203, a code register (C-REG) 204, an EOR adding circuit 53, and a consistency detection circuit 54.

The memory 27 includes a storage area (g′-CRC) 271 for storing a polynomial g′(x) having been performed reduction necessary for CRC computation, a storage area (g-ECC) 272 for storing an irreducible polynomial g(x) necessary for ECC computation, an encryption key (public-key) storage area (E-KEY) 273, and a decryption key (private-key) storage area (D-KEY) 274.

In the buffer memory 26, a buffer area (Tx-BUF) 261A for storing a transmitting message supplied from the core processor 10, a buffer area (Tx-ENC) 262A for storing an encrypted transmitting message, a buffer area (Rx-CRC) 263B for storing a receiving message with CRC supplied from the receiving part, a buffer area (Rx-ENC) 262B for storing an encrypted receiving message from which CRC is removed, and a buffer area (Rx-BUF) 261B for storing a decrypted receiving message are defined. A message is transmitted and received between the core processor 10 and the processing part 20 via the Tx-BUF area 261A and the Rx-BUF area 261B.

The processing part (code computing apparatus) 20 for processing transmitting and receiving data shown in this embodiment includes, as its operation modes, a matrix element computing mode, a transmitting data encryption mode, a transmitting data error encryption mode, a receiving data error detection mode, and an encrypted data decryption mode. These operation modes are switched by the control part 70.

When generating a matrix element for ECC encryption in the matrix element computing mode, for instance, the control part 70 starts the matrix element computation part 30 in a state that the coefficient values of the irreducible polynomial g(x) read out from the memory area 272 are set to the G-REG 202 and an encryption key read out from the memory area 273 is set to the A-REG 201. The generated matrix elements are held in an encoding matrix area of the memory 50.

In the same manner, matrix elements for ECC decryption are generated in the state that the coefficient values of the irreducible polynomial g(x) are set from the memory area 272 to the G-REG 202 and a decryption key is set from the memory area 274 to the A-REG 201. The matrix elements generated by the matrix element computation part 30 are held in a decoding matrix area of the memory 50.

The element values for CRC matrix are generated in the state that the coefficient values of g′(x) are set from the memory area 271 to the A-REG 201 and the G-REG 202. The matrix elements generated by the matrix element computation part 30 are held in a CRC matrix area of the memory 50.

In the case where each of the A-REG 201 and the G-REG 202 has a 32-bit length corresponding to the parameter length for CRC computation, the element values of CRC matrix can be calculated through one parameter loading to these registers. However, the parameter for ECC computation is longer than that for CRC computation. Accordingly, the matrix elements for ECC encryption and decryption are generated as described later by repeating the matrix element computation a plurality of times while reading out the irreducible polynomial g(x) and the encryption key in units of 32 bits from the memory 27 and switching the parameters set in the registers 201 and 202 for each computation.

In the transmitting data encryption mode, transmitting data read out in units of 32-bit of sub-block from the Tx-BUF area of the buffer memory is supplied to the B-REG 203, and elements of the partial matrix necessary for encryption of transmitting data are loaded from the memory 50 to the M-REG 51. After that, the inner product calculation part 40 is started. In this case, the inner product calculations is repeated on one data block set in the B-REG 203 a plurality of times while switching the contents of the M-REG 50.

The calculation result of the inner product calculation part 40 is outputted to the C-REG register 204. The calculation result outputted to the C-REG register 204 is held in the C-MEM 52 as an intermediate result of the calculation. The C-MEM 52 has a storage capacity having the number of bits corresponding to an ECC code length. The EOR adding circuit 53 adds a new calculation result to the intermediate result of the calculation corresponding to the submatrix in each inner product calculation cycle.

When the encryption calculation processing of the transmitting data for a plurality of sub-blocks corresponding to the ECC code length has been completed, the contents of the C-MEM 52 are read out as encrypted data to the Tx-ENC area 262A of the buffer memory 26.

When the encryption processing for one message stored in the Tx-BUF area has been completed through the repetition of the above-described inner product calculation, the operation mode is switched to the transmitting data error encryption mode (CRC computation mode).

In the transmitting data error encryption mode, in the state of loading the elements of CRC matrix from the MAT-MEM 50 to the M-REG 51, the encrypted data block is read out in units of 32 bits from the Tx-ENC area 262A of the buffer memory 26 and transferred to the B-REG register 203 and the transmission part 11. If the transmitting data need not be encrypted, the data block read out from the Tx-BUF area 261A of the buffer memory 26 is supplied to the B-REG register 203 and the transmission part 11.

The inner product calculation part 40 executes inner product calculation between the data block stored in the B-REG register 203 and the elements of CRC matrix indicated by the M-REG 51 to output the calculation result to the C-REG register 204. In this case, the calculation result outputted to the C-REG register 204 is transferred as a CRC code to be added to the data block already supplied, via the bus 29 to the transmission part 10.

In the receiving data error detection mode, by selecting receiving data read out from the Rx-CRC area 263 of the buffer memory 26 as a calculation object, the inner product calculation part 40 executes inner product calculation between the data block stored in the B-REG register 203 and the elements of CRC matrix indicated by the M-REG 51.

In this case, the receiving data is stored in the Rx-CRC area 263B in a form added with a 32-bit CRC code block for each 32-bit data block. The presence or absence of an error of the received data can be judged, for instance, by reading out a 32-bit data block to generate CRC r(x) in the first cycle, reading out a 32-bit CRC code block subsequent to the data block in the second cycle to generate CRC r′(x), and checking the consistency of r′(x) of r(x).

The consistency detection of the r′(x) and r(x) is performed by the consistency detection circuit 54 and the detected result is notified to the control part 70. The control part 70 transfers the data block having been performed error-detection to the Rx-ENC area 262B (the Rx-BUF area 261B for an unencrypted plain data block) of the buffer memory. If error is detected, the control part 70 discards the error data block.

In the encrypted data decryption mode, by selecting the data block read out from the Rx-ENC area 262B as a calculation object, the same calculation as the transmitting data encryption mode is performed by the inner product calculation part 40. The decrypted data is transferred from the C-MEM 52 to the Rx-BUF area 261B.

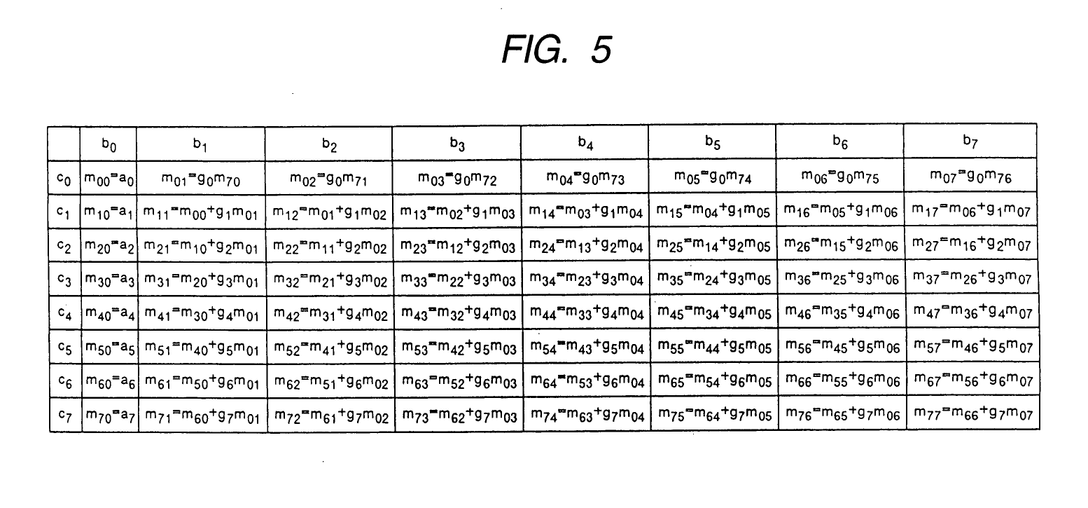

FIG. 5 shows an example of a matrix M generated by the matrix element computation part 30.

In the explanation of the embodiment of FIG. 4, the matrix element computation part 30 generates a matrix of a 32×32 size. Here, for simplification, a matrix of 8×8 is shown. Symbols b₀ to b₇ indicate data bits set to the B-REG 203, and c₀ to c₇ the bits of CRC or ECC outputted as calculation results to the C-REG 204. The values (m₀₀ to m₇₀) in the first column of the matrix M are determined by each of bit values (a₀ to a₇) of the polynomial a(x).

The values (m₀₁ to m₇₇) after the second column are basically in the relation of equation (14).
m(i, j)=m(i−1, j−1)+g(i)m(0, j) (14)
The values (m₀₁, m₀₂, m₀₃ . . . m₀₇) in the first row in each of the columns are in the relation of equation (15).
m(0, j)=g(0)m(max, j−1) (15)
Here, m (max, j−1) means the matrix element in the last row in the (j−1)-th column.

Each of the coefficients of the polynomial g(x) has a fixed value defined by the standards. In the case of ECC encryption/decryption, the polynomial a(x) is an encryption key and has a fixed value or semi-fixed value in a certain period. In the case of error detection, the polynomial g′(x) to be used in place of a(x) has a perfect fixed value. Accordingly, since the matrix M generated from these parameters has a fixed or semi-fixed value, if the coefficient values are once computed by the matrix element computation part 30, the calculation result can be repeatedly used.

The matrix computation capacity of the matrix element computation part 30 and the inner product calculation part 40 has a limited size (hereinafter, called a basic size) like 16×16 or 32×32 from the limit of hardware. In order to treat a matrix M of an n×n size larger than the basic size, it is required to divide the matrix M into a plurality of submatrices having the basic size and repeat the computing operation for each of the submatrices.

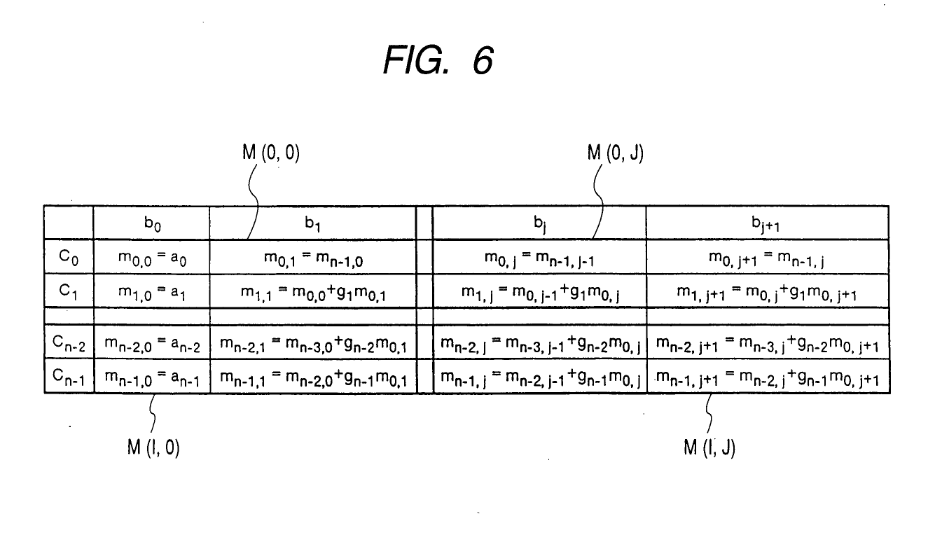

FIG. 6 shows an example in which a matrix M of n×n is divided into submatrices M(0,0) to M(I,J).

Here, for instance, the value of a matrix element m (0, 1) in the first row (the row of the calculation result c₀) in the second column (the column of the data bit b₁) of the first submatrix M(0,0) depends on the matrix element m(n−1,0) in the last row in the first column (the column of the data bit bo) of the submatrix M(I,0) located in the lower left side of the matrix M. The value of a matrix element m(k,1) in the first row in the second column of the next submatrix M(1,0), which is omitted from the drawing, depends on the matrix element m(k−1,0) in the last row in the first column of the first submatrix M(0,0). Except for the first column (the column of the data bit b₀) of the entire matrix M, the element in the first row (the row of the calculation result c₀) of the matrix M in each of the columns is reflected on all subsequent rows (the rows of the calculation results c₁ to cₙ₋₁).

When generating matrix element values for each submatrix by the matrix element computation part 30, parameters must be set in considering these boundary conditions.

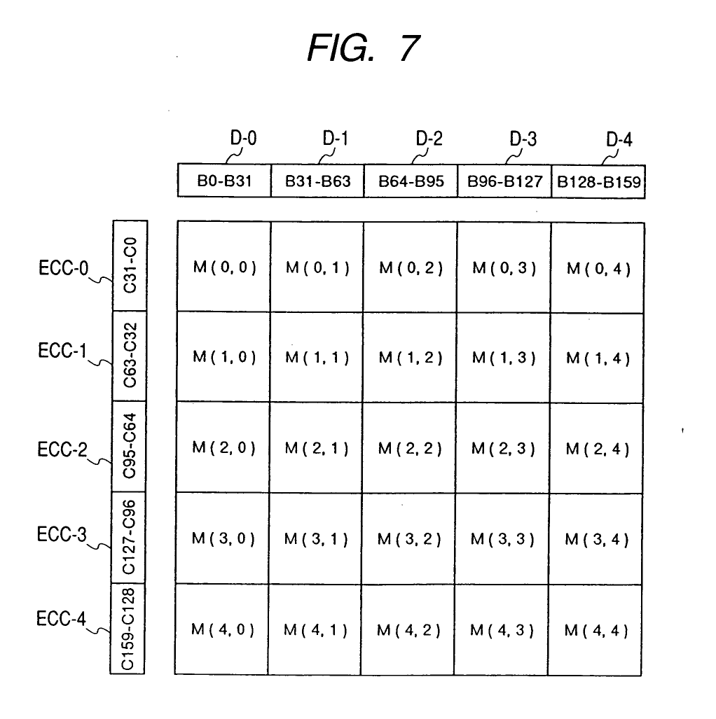

FIG. 7 shows the relation among the arrays of the submatrices M(0,0) to M(4,4), input data (B01 to B159) and output codes (C01 to C159) in the case where a matrix with 160×160 bits is divided into a plurality of blocks having the basic size of 32×32.

When handling such submatrices, the input data (B01 to B159) is inputted to the inner product calculation part 40 in a form divided into data blocks D-0 to D-4 in units of 32 bits and the output codes (C01 to C159) are outputted in a form divided into the code blocks ECC-0 to ECC-4 in units of 32 bits.

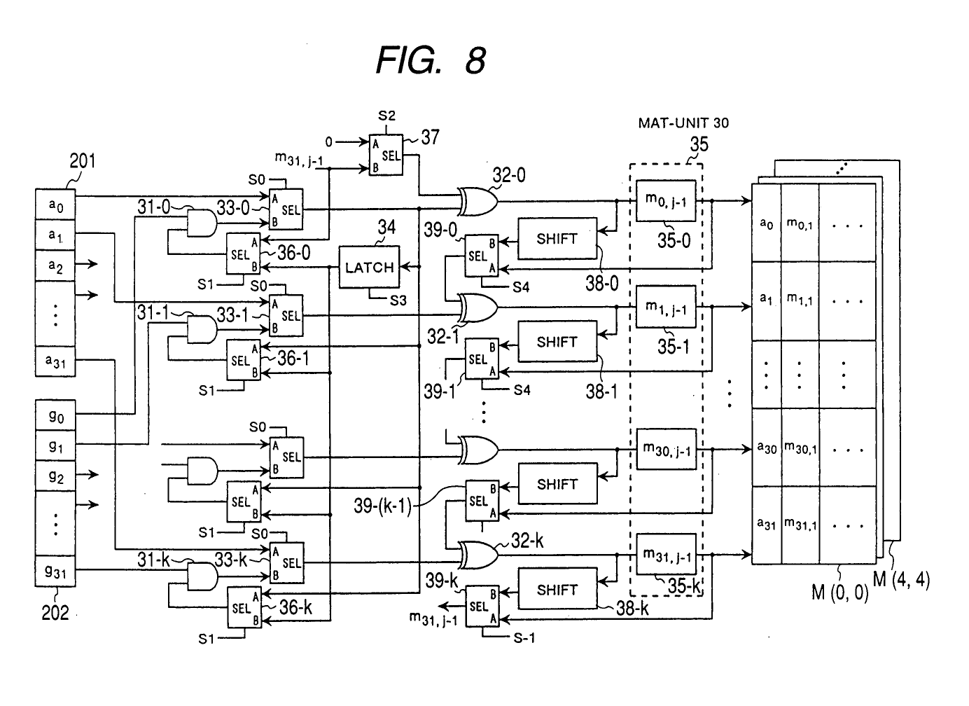

FIG. 8 shows an embodiment of the matrix element computation part 30 for generating the elements of ECC matrix for each submatrix with 32×32 bits.

The matrix element computation part 30 is comprised of a plurality of AND circuits 31-i, a first group of selectors 33-i, and exclusive OR (EOR) circuits 32-i (i=0 to k, k=31), which are prepared so as to be corresponding to each of the bits of the A-REG 201 and the G-REG 202, and a register 35 having a plurality of bits of storage areas 35-i (i=0 to k) for holding the output values of the EOR circuits.

Any one of the value “ai” of the i-th bit stored in the A-REG 201 and the output value of the AND circuit 31-i is selectively supplied to the first input of each of the EOR circuits 32-i via the selectors 33-i controlled by a control signal S0 from the control part 70. As the second input of the EOR circuits 32-i (i=1 to k), except for the first EOR circuit 32-0, the matrix element m(i−1,j−1) in the previous row in the previous column held in the register 35 is supplied. As the second input of the first EOR circuit 32-0, a fixed value “0” or the matrix element m(31, j−1) in the last row in the previous column held in the last bit storage area 35-k of the register 35 is supplied via a selector 37 controlled by a control signal S2 from the control part 70. The matrix element in the first row of the submatrix outputted from the selector 33-0 is held in a latch circuit 34 at predetermined timing specified by a control signal S3 from the control part 70.

The value “gi” of the i-th bit stored in the G-REG 202 is supplied as the first input of each of the AND circuits 31-i. As the second input of the first AND circuit 31-0, any one of the matrix element m(31,j−1) in the last row in the previous column and the matrix element in the first row of the submatrix held in the latch circuit 34 is supplied via the selector 36-0. As the second input of each of the other AND circuits 31-i (i=1 to k), any one of the output value of the selector 33-0 and the matrix element in the first row of the submatrix held in the latch circuit 34 is supplied via the selectors 36-i. The selectors 36-0 to 36-k constitute a second group of selectors and are controlled by a control signal S1 from the control part 70.

In this embodiment, in order to apply to the CRC matrix computation and ECC matrix computation, the matrix element computation part 30 includes a plurality of shift registers (SHIFT) 38-i each for holding the output bit of the EOR circuits 32-i, and a third group of selectors 39-i (i=0 to k) each for selecting any one of the output value of the shift register 38-i and the output value of the register area 35-i to supply the selected output value to the EOR circuits 32-(i+1) in the next row. Each of the third group of selectors, except for the last selector 39-k controlled by the control signal S1, selects any one of the inputs of A port and B port according to a control signal S4.

When generating the elements of CRC matrix, the control part 70 outputs the control signals S1, S2 and S4 so that each of the selector 37, the second group of selectors 36-0 to 36-k, and the third group of selectors 38-0 to 38-k constantly selects the input of A port. The control signal S0 is switched so that each of the first group of selectors 33-0 to 33-k selects the input of A port (the output of the A-REG) in the computation cycle of the matrix elements in the first column of the matrix M and selects the input of B port (the output of the AND circuit 31-i) in the computation cycle of the matrix elements in the second to k-th column (k=31) of the matrix M.

Accordingly, in the computation cycle of the matrix elements in the first column, each of the bit values a₀ to a₃₁ indicated by the A-REG 201 is generated from the EOR circuits 32-i (i=0 to k). These bit values are temporally set to the storage areas 35-0 to 35-k of the register 35 and thereafter stored in the CRC matrix area of the MAT-MEM 50. In the illustrated example, these bit values are stored in the first column of M(0,0).

In the computation cycle of the matrix elements in the second column, the value of element (m_{0,1}) indicating the result of AND between the matrix element a₃₁ in the last row in the previous cycle indicated by the storage area 35-k selected by the selector 36-0 and the first bit value g₀ indicated by the G-REG 202 is outputted from the selector 33-0 in the first row and this value is inputted to the EOR circuit 32-0. The value of element (m_{0,1}) is also inputted to the other AND circuits 31-i via the second group of selectors 36-i (i=1 to k). Accordingly, the value indicating “gᵢ·m_{0,1}” is outputted from each of the selectors 33-i after the first row and a matrix element indicated by the equation (14) is outputted from each of the EOR circuits 32-i.

In the computation cycles of the matrix elements in the second to k-th column, the same computing operation is repeated, thereby to generate matrix elements according to the equations (14) and (15) in the CRC matrix area M(0,0).

When generating the elements of ECC matrix, in the state that each of the third group of registers 39-i (i=0 to k) selects the input of B port, the computation cycle of the matrix elements in the first column of the matrix M is repeated while replacing the set parameters of the A-REG 201. In these computation cycles, the values of a0 to a31, a32 to a63, . . . a128 to a159 are generated successively in the register 35 and are stored in the first column of the submatrices M(0,0), M(1,0), . . . M(4,0).

At this time, the bit values of a₀, a₃₂, a₆₄, a₉₆ and a₁₂₈ are held in the first shift register 38-0, and the bit values of a₁, a₃₃, a₆₅, a₉₇ and a₁₂₉ are held in the next shift register 38-1. The bit values of a₃₁, a₆₃, a₉₂, a₁₂₇ and a₁₅₉ are held in the last shift register 38-k.

When the matrix computation for the first column has been completed, the control signals S0 and S2 are switched so that each of the first group of selectors 33-i and the selector 37 selects the respective inputs of B port. At this time, the parameter value “a₁₅₉” is set as the matrix element (m_{31, J-1}) in the storage area 35-k of the register 35. After this, computation cycles of the matrix elements in the first column of the submatrices M(0,0), M(1,0), . . . M(4,0) are repeated while replacing the set value of the G-REG 202.

In the computation cycle in which the parameter values g₀ to g₃₁ of the first block are set in the G-REG 202, the control signal S1 is switched so that each of the second group of selectors 36-i and the last selector 39-k of the second group of selectors selects the input of A port, and the output value “g₀·a₁₅₉” of the selector 33-0 is inputted to the AND circuits 31-i in other rows. The output value “g₀·a₁₅₉” of the selector 33-0 is stored in the latch circuit 34 by a latch signal given by the control signal S3. In this case, since the bit value m(0, j−1) in the previous row in the previous column outputted from the shift registers 38-(j−1) is inputted to the EOR circuits 32-j, the matrix elements (m_{0,1}) to (m_{31,1}) in the second row are generated according to the equations (14) and (15). These values are stored in the shift registers 38-0 to 38-k and the second column of the ECC submatrix M(0,0) of the MAT-MEM 50.

In each of the computation cycles performed in the state that the parameter values of the first block (g₃₂ to g₆₃) to the fourth block (g₁₂₇ to g₁₅₉) are set in the G-REG 202, the control signal S1 is switched so that each of the second group of selectors 36-i and the last selector 38-k of the third selectors select the input of B port. That is, the value “g₀·a₁₅₉” stored in the latch circuit 34 is reflected on the matrix elements of the submatrices M(1,0) to M(4,0). According to this operation, the value of matrix elements (m_{32,1} to m_{63,1}) to (m_{127,1} to m_{159,1}) in the first row according to the equations (14) and (15) are generated successively, and these values are stored in the second column of the submatrices M(1,0) to M(4,0) of the MAT-MEM 50.

The values of matrix elements in the third to 32nd column of the submatrices M(0,0), M(1,0), . . . . M(4,0) are generated by repeating the same procedure as the second column. For the remaining submatrices M(0,1), M(1,1), . . . M(4,4), the set value of the G-REG 202 are used for all matrix computation from the first to 32nd column, and the same procedure as the computation cycle after the second column of the submatrices M(0,0), M(1,0), . . . M(4,0) are repeated.

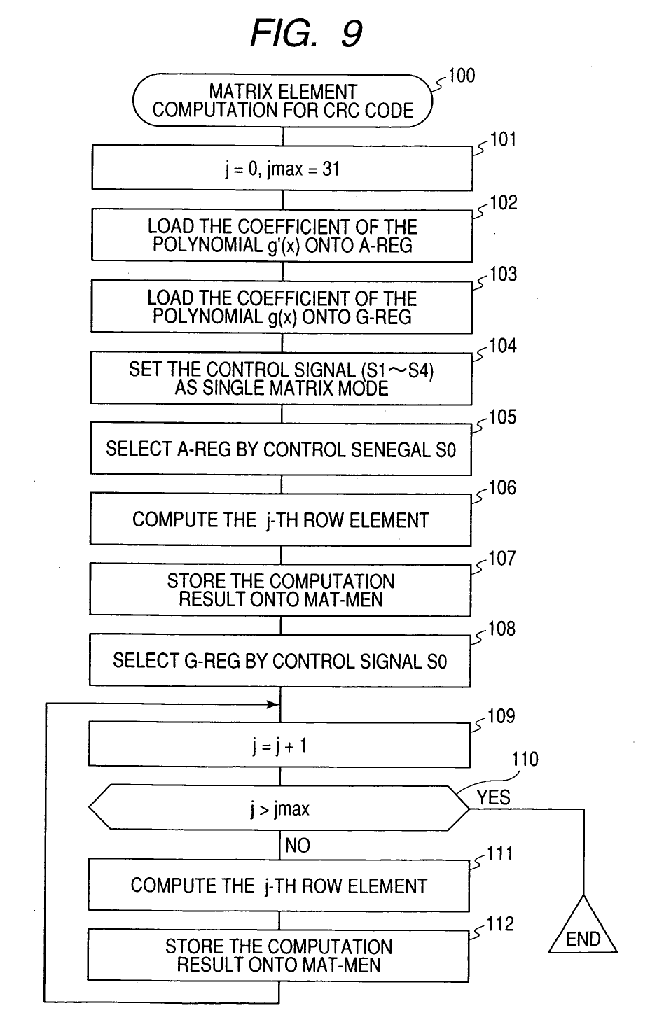

FIG. 9 shows an embodiment of a CRC matrix element generation routine 100 to be executed by the control part 70 to control the matrix element computation part 30 shown in FIG. 8.

In the CRC matrix element generation routine 100, a parameter i for specifying a column is initialized to have an initial value 0, and a value 31 is set as the value of a parameter jmax for indicating the last column (step 101), and the coefficients of g′-CRC read out from the memory area 271 is loaded into the A-REG 201 and the G-REG 202 (steps 102 and 103). Next, the generation patterns of the control signals S1 to S4 are set as a single matrix mode. Here, the single matrix mode means that the matrix element computation is completed by a single submatrix having the basic size of 32×32 bits. In this mode, the control signals S1, S2 and S4 are brought to the state that each of the second and third groups of selectors 36-i and 39-i (i=0 to k) and the selector 37 constantly selects the input of A port, and the control signal S3 is brought to the state of producing no latch signal.

At first, the control signal S0 is generated so that each of the first group of selectors 33-i (i=0 to k) selects the output of the A-REG 201 (the input of A port) (105), then the matrix elements in the j-th column are computed by the EOR circuits 32-i (i=0 to k) (106). The computation results of the j-th column outputted from the EOR circuit are held in the an initial value 0, a value 4 is set as the maximum value Imax and Jmax of the parameters I and J, and a value 31 is set as the maximum value jmax of j (121).

Next, the generation patterns of the control signals S1, S2, S3 and S4 are set to a submatrix mode. Here, the submatrix mode means that the computation of matrix elements is executed by dividing the matrix into a plurality of submatrices. In this mode, the control signal S1 is switched so that each of the second group of selectors 36-i (i=0 to k) and the selector 39-k selects the input of A port in the computation cycle of the submatrix M(0,J) and selects the input of B port in the computation cycles of other submatrices M(I,J) (I=1 to 4). The control signal S2 is switched so that the selector 37 selects the input of A port in the computation cycle in the first column of the submatrices M(I,0) (I=0 to 4) and thereafter selects the input of B port.

The control signal S3 produces a latch signal in the computation cycles for each column of the submatrix M(0,J) to hold the output values of the selector 33-0 in the latch circuit 34. The output value of the latch circuit 34 is not changed in the computation cycles of the submatrices M(1,J) to M(4,J). The control signal S4 is in a state that each of the third group of selectors 39-i (i=0 to k−1) constantly selects the input of A port.

First, by generating the control signal S0, each of the first group of selectors 33-i (i=0 to k) selects the output of the A-REG 201 (the input of A port) (123) so that the I-th block KEY(I) of an encryption key is loaded from the E-KEY area 273 of the memory 27 to the A-REG 201 (124). At this time, each of the EOR circuits 32-i (i=0 to k) computes the matrix elements in the first column of the submatrix M(I,J) according to the 32 bits of parameter indicated by the KEY(I) (125). The computation results are held in the shift register 38 and the register 35, and stored thereafter in the j-th column of the ECC submatrix area M(I,J) defined in the MAT-MEM 50 (126).

Next, the value of the parameter I is incremented (127), and the value of I is compared with Imax (128). If not I>Imax, the program sequence is returned to step 124 to load the next block of an encryption key KEY(I) from the E-KEY area 273 to the A-REG 201 to repeat the same operation as above.

If I>Imax, the status of the control signal S0 is switched so that each of the first group of selectors 33 selects the output of the G-REG 202 (the input of B port) (130), the vaslue of the parameter I is returned to the initial value 0 and the value of the parameter j is incremented (133).

Next, the value of the parameter j is compared with jmax (134). If not j>jmax, the I-th block g-ECC(I) of the coefficients of polynomial g(x) is loaded from the g-ECC area 272 of the memory 27 to the A-REG 201 (135). By this operations, the EOR circuits 32-i (i=0 to k) can compute the j-th column elements of the submatrix M (I, J) according to the 32 bits of parameter indicated by the block g-ECC(I) (136). The computation results are held in the register 35 and stored in the j-th column of the ECC submatrix area M(I,J) defined in the MAT-MEM 50 (137).

Next, the value of the parameter I is incremented (138), and the value I is compared with Imax (139). If not I>Imax, the program sequence is returned to step 135 to load the next block g-ECC(I) from the E-KEY area 273 to the A-REG 201 to repeat the same operation as above. If I>Imax in step 139, the program sequence is returned to step 133 to return the value of the parameter I to the initial value 0 and increment the value of the parameter j. After that, the same procedure is repeated for the matrix elements of the next column.

If j>jmax in step 134, the program sequence is advanced to step 140 to return the values of the parameter j and I to the initial value 0 and increment the value of the parameter J, whereby the computation object is changed to the submatrix M(I,J) in the next column. The value of the parameter J is compared with Jmax (141). If J>Jmax, the routine is terminated. If not J>Jmax, the program sequence is advanced to step 135 to repeat the above-described computing operation of the matrix elements for the first to 32nd columns in the submatrices M(0,J) to M(4,J).

In the execution process of the steps 133 to 141, the matrix elements in the first row of the matrix M are held in the latch circuit 34 by a latch signal given by the control signal S3 in the computation cycle for each column of the submatrix M(0,J). This values are supplied to the AND circuits 31-0 to 31-k in each of the computation cycles for the subsequent submatrices M(1,J) to M(4,J). Since the matrix element in the last row in the previous column outputted from the last storage area 35-k of the register 35 is supplied to the EOR circuit 32-0 in the first row shown in FIG. 8, the boundary condition of the submatrices described in FIG. 6 can be satisfied.

Although the matrix element generation routine for ECC encryption is described above, by applying the decryption key read out from the D-KEY area of the memory 27 as the block KEY(I), it is able to generate the matrix elements for ECC decryption by the same control procedure as the routine 120.

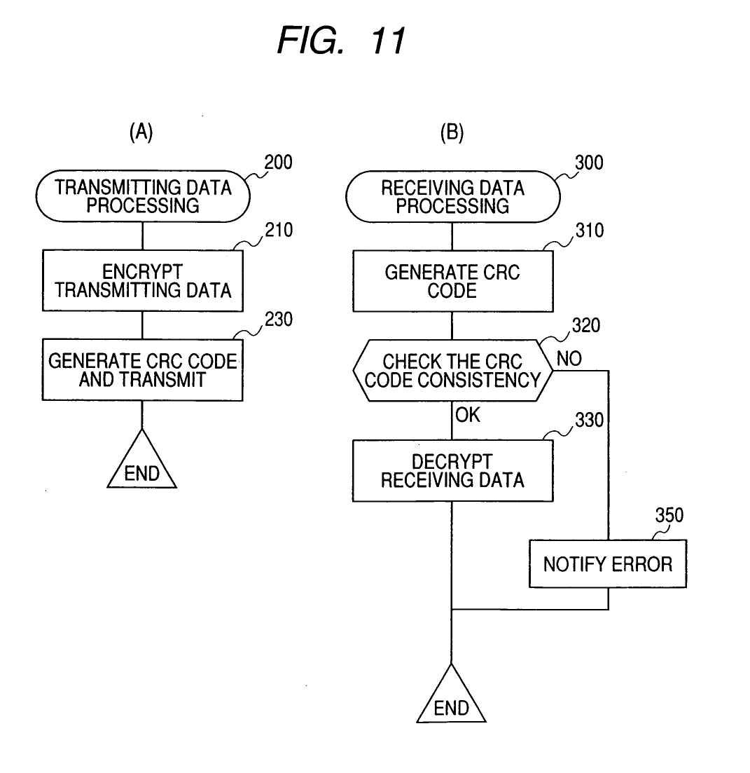

FIGS. 11(A) and 11(B) show a flowchart of a transmitting data processing routine 200 and a flowchart of a receiving data processing routine 300 to be executed by the control part 70 to control the inner product calculation part 40.

The transmitting data processing routine 200 includes encryption processing (210) of transmitting data (transmitting message) read out from the Tx-BUF area 261A in the buffer memory 26 and CRC generation/transmission processing (230) of encrypted data read out from the Tx-ENC area 262A. When the transmitting data need not be encrypted, the CRC generation/transmission processing (230) is executed on the transmitting data read out from the Tx-BUF area 261A.

The receiving data processing routine 300 includes CRC generation processing (310) of the receiving data stored in the Rx-CRC area 263B of the buffer memory 26, CRC code consistency check (320), and decryption processing (330) of the receiving data judged to have no errors in the CRC code consistency check 320. In the decryption processing (330), it is judges whether the receiving data is encrypted data or not. If the receiving data is not encrypted data, the receiving data is transferred to the Rx-BUF area 161B. If the receiving data is encrypted data, the receiving data is decrypted and transferred to the Rx-BUF area 161B. For the receiving data in which an error is detected as a result of the CRC check, error processing (350) such as error notification to the core processor 10 as a master apparatus is executed. The transmitting data processing routine 200 and the receiving data processing routine 300 are executed alternately for each message.

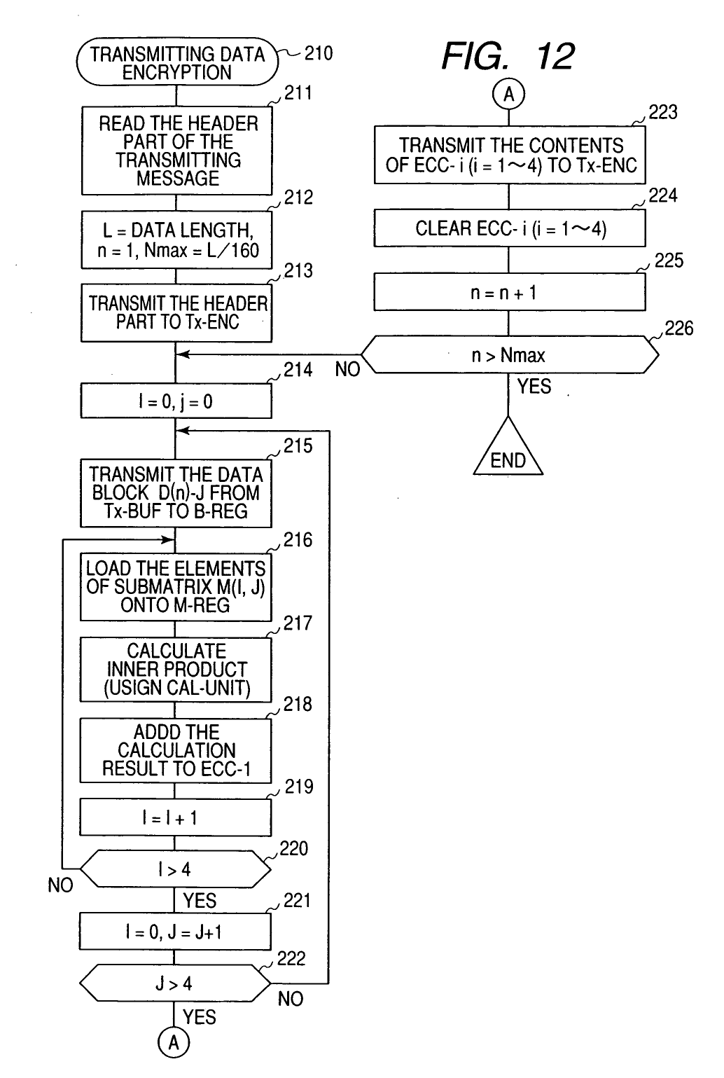

FIG. 12 is a flowchart showing an embodiment of the transmitting data encryption processing 210.

The control part 70 reads out the header part of transmitting data from the Tx-BUF area 261A (211), calculates, from data length L indicated by the header part, the number Nmax of blocks in the case where the transmitting data is divided into blocks having the block length of encrypted data (in this case, 160 bits), and initializes the value of parameter n for indicating the number of times of repetition of the encryption processing to have an initial value 1 (212). In this embodiment, the header part is excluded from the encryption object and the encrypted data is transferred to the Tx-ENC area 262A (213).

First, each of the values of the parameters I and J for specifying a submatrix M(I, J) are initialized to have an initial value 0 (214). The n-th data block of the transmitting data is read out in units of 32 bits from the Tx-BUF area 261A to transfer it to the B-REG 203 (215). Here, the 32 bits of data block read out to the B-REG 203 is expressed as D(n)-J. The first data block D(n)-0 read out corresponds to the data D-0 in FIG. 7, and the next data block D(n)-1 read out corresponds to the data D-1.

Next, the submatrix M (I, J) for encryption is loaded from the memory 50 to the M-REG 51 (216) and the inner product calculation part 40 is started (217). Then, the results of inner product calculation between the submatrix M(I, J) and the data D(n)-J is outputted to the C-REG 204. In the first inner product calculation using the submatrix M(0,0), the values of C0 to C31 shown in FIG. 7 are calculated. As the obtained values are merely the sub-calculation values of the ECC code in this case, they are EOR added to the pre-computed values in the ECC-I area of a C-MEM 52 (218). In the C-MEM 52, code value storage areas ECC-0 to ECC-4 each having a 32-bit length are prepared so as to be corresponding to the parameter J of the submatrix M(I,J). The initial value of each of the areas is 0.

The value of the parameter I is incremented (219) and it is judge whether I>4 or not (220). If the value of I is 4 or below, the program sequence is returned to step 216 in order to repeat the same operation. According to these operations, the inner product calculation between the data D-0 and the submatrices M 1,0) and M(4,0) is executed successively, and the calculation results C32-C63 to C128-C159 are EOR added to the pre-computed values in the ECC-1 to ECC-4 of the C-MEM 52.

As a result of incrementing the parameter I, when the value of I becomes grater than 4, the value of I is returned to the initial value 0 and the value of J is incremented (221) to judge whether J>4 (222). If the value of J is equal to or below 4, the program sequence is returned to step 215 in order to transfer the next block D(n)-J of the transmitting data from the Tx-BUF area 261A to the B-REG 203 and to repeat the operations of the steps 215 to 222. By repeating the operations until the value of J exceeds 4, the inner product calculation between the data D-1 and the submatrices M(0,1) to M(4,1), between the data D-2 and the submatrices M(0,2) to M(4, 2), between the data D-3 and the submatrices M(0,3) to M(4, 3), and between the data D-4 and the submatrices M(0,4) to M(4, 4) shown in FIG. 7 are executes successively. The inner product calculation results are EOR added to the ECC-0 to ECC-4 in the C-MEM 52 successively.

When the value of the parameter J is J>4, the contents (ECC-0 to ECC-4) of the C-MEM 52 indicate the encrypted result of the transmitting data having a 160-bit length. Accordingly, the contents of the C-MEM 52 are transferred to the Tx-ENC area 262A of the buffer memory (223). After clearing the ECC-0 to ECC-4 in the C-MEM 52 (224), the value of the parameter n is incremented (225) to compare it with the maximum value Nmax (226). If not n>Nmax, the program sequence is returned to step 214 so that the encryption processing on the next transmitting data D(n) having a 160-bit length is performed. When n>Nmax, encryption of one transmitting message is completed.

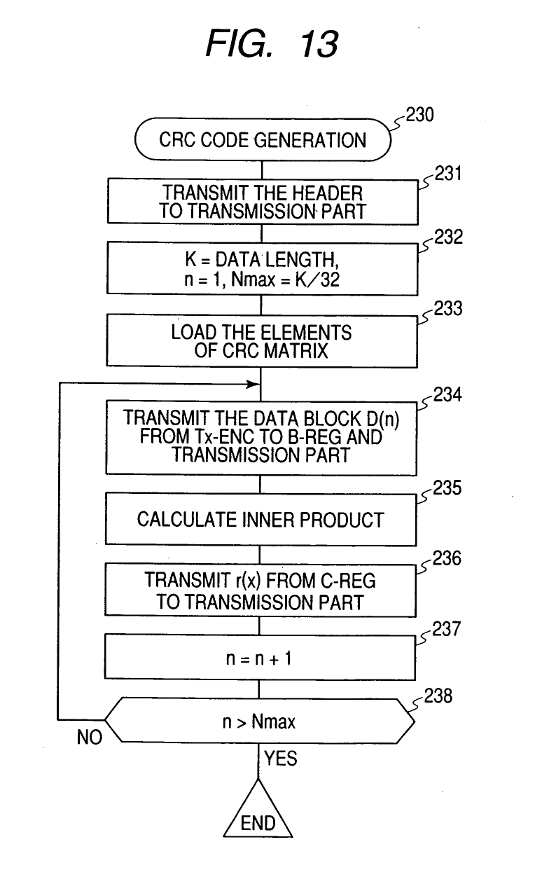

FIG. 13 is a flowchart showing an embodiment of the CRC generation/transmission processing (230).

In the CRC generation/transmission processing (230), encrypted data is read out in units of 32 bits from the Tx-ENC area 262A to generate CRC. Here, description will be given in the case of encrypted transmitting data. In the case of sending unencrypted transmitting data, the data in the Tx-BUF area 261A may be treated as a CRC generation object.

The header part of the transmitting message is read out from the Tx-ENC area 262A to transfer it to the transmission part 11(231). Next, the number of data blocks Nmax is calculated in the case where the length K of the encrypted data is read out in units of 32 bits, and the value of the parameter n indicating the number of times of repetition of the processing is initialized to have an initial value “1” (232).

After loading the elements of CRC matrix from the memory 50 to the M-REG 51 (233), the first data block D(n) of the encrypted transmitting data is read out from the Tx-ENC area 262A to transfer it to the transmission part 11 and the B-REG 203 (234). By starting the inner product calculation part 40 in this state (235), the results C0 to C31 of inner product calculation between the CRC matrix M and the data D(n) are outputted to the C-REG 204.

In the case of CRC generation, since a whole CRC code to be added to the data block D(n) can be generated by once of starting the inner product calculation part 40, the contents of the C-REG 204 are transmitted to the transmission part 11 (236). After that, the value of the parameter n is incremented (237) to compare it with Nmax (238). When n is, equal to or below Nmax, the program sequence is returned to step 234 to read out the next data block D(n) from the Tx-ENC area 262A and to repeat the above-described operation. When n>Nmax, the CRC generation processing for one message is completed.

CRC generation processing 310 in the receiving data processing routine 300 shown in FIG. 11 is realized by modifying the CRC generation routine of the transmitting data described in FIG. 13 in such a manner that the Rx-CRC area 263B is used instead of the Tx-ENC area 262A as the storage area from which the data block is read out, and the destination of the header, data block and CRC is changed from the transmission part 11 to the Rx-ENC area 262B (the Tx-BUF area 261B in the case of plain receiving data) of the buffer memory.

Since the receiving data decryption processing 330 may perform inner product calculation processing, using the decryption submatrix loaded from the memory 50 to the M-REG 51, on the data block read out from the Rx-ENC area 262B, it has the same procedure basically as the transmitting data encryption routine described in FIG. 12.

In the above embodiment, the CRC and ECC matrices generated by the matrix element computation part 30 are stored in the memory (MAT-MEM) 50, and when performing CRC generation and ECC encryption/decryption processing, the matrix elements necessary for the inner product calculation part 40 are suitably loaded from the MAT-MEM 50 to the M-REG 51. The M-REG 51 may be prepared as exclusive registers for CRC and ECC encryption and decryption, thereby to directly load the matrix elements generated by the matrix element computation part 30 to these exclusive registers. In this case, it is able to perform CRC generation and ECC encryption/decryption processing at high speed by switching the M-REG 51 to be connected to the inner product computation part 40.

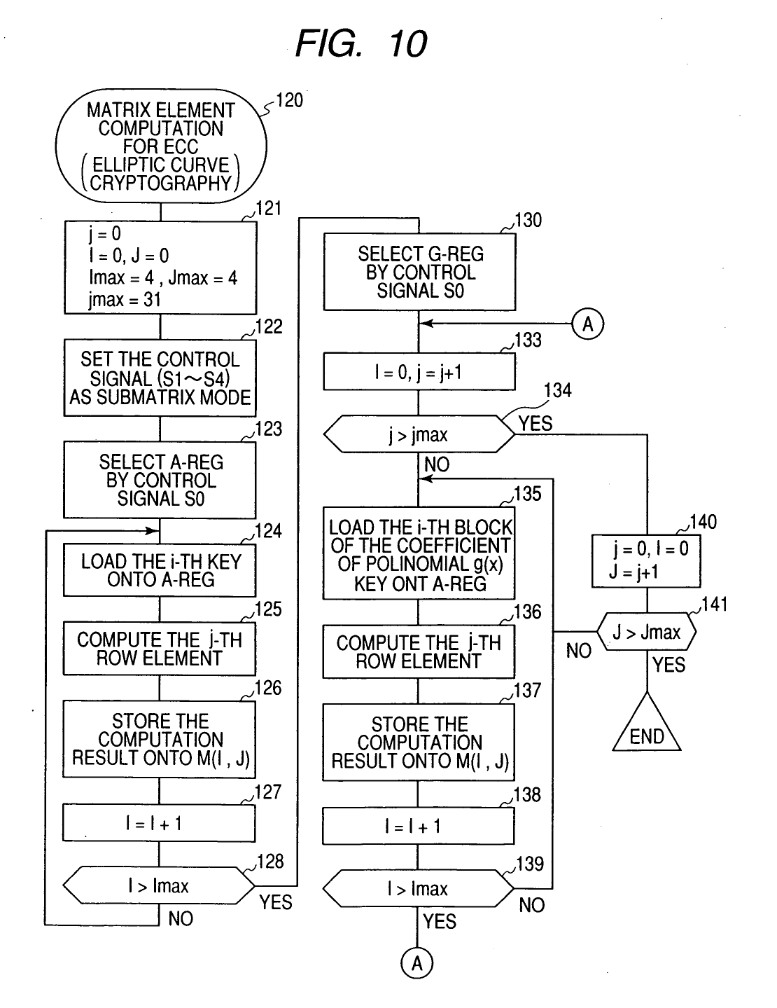

In this embodiment, the basic size of the matrix generated by the matrix element computation part is 32×32. When the basic size becomes smaller, for instance, to 8×8 or 16×16, the CRC matrix has to be generated in the submatrix mode. In this case, the same control method as the ECC matrix element generation routine 120 described in FIG. 10 may be employed in the CRC matrix element generation routine 100.

According to the present invention, by applying matrix elements prepared in advance, a CRC code necessary for error detection of transmitting/receiving data can be generated at high speed. Further, by using the matrix element computation part for generating the matrix for CRC, it is able to rapidly generate the matrix elements for ECC encryption and decryption. Accordingly, if it is desired to suitably change the encryption key in order to increase the safety, by supplying encryption key data from outside and instructing the control part 70 to execute the ECC matrix generation routine, it becomes easy to generate new matrix elements according to the encryption key.

### INDUSTRIAL APPLICABILITY

According to the present invention, as the same hardware (the matrix element computation part and the inner product calculation part) is applicable in common to the error detection code generation and encryption processing, a compact packet communication apparatus can be provided. Further, matrix elements necessary for encryption/decryption processing are generated in the packet communication apparatus, it becomes easy to change an encryption key to increase the safety of transmitting/receiving data.

What is claimed is:

1. A code computing apparatus comprising:
first and second registers (201 and 202) in which parameters having a predetermined bit length are set, respectively;
a third register (203) in which data to be encrypted is set;
a matrix element computation part (30) for generating matrix elements from the values set in said first and second registers;
a matrix element register (51) for holding the matrix elements generated by said matrix element computation part; and
an inner product calculation part (40) for executing inner product calculation between the matrix elements held by said matrix element register and the data set in said third register, wherein
said matrix element computation part selectively generates matrix elements for error detection and matrix elements for encryption by changing the parameters to be set in said first and second registers, and
said inner product calculation part selectively performs error control code generation and data encryption by altering the matrix elements to be held in said matrix element register.

2. A code computing apparatus comprising:
first and second registers (201 and 202) for storing, at least one of them, coefficient data of a polynomial of degree n;
a third register (203) in which data to be encrypted is set;
a matrix element computation part (30) for generating matrix elements of n×n from the value set in said first and second registers;
a matrix element register (51) for holding the matrix elements generated by said matrix element computation part; and
an inner product calculation part (40) for executing inner product calculation between the matrix elements held by said matrix element register and the data set in said third register; wherein
said inner product calculation part produces encrypted data of transmitting data or receiving data supplied to said third register.

3. The code computing apparatus according to claim 2, wherein
said matrix element computation part generates matrix elements for error detection, and said inner product calculation part generates an error detection code corresponding to the data set in said third register.

4. The code computing apparatus according to claim 3, wherein
coefficient data (g′) of a polynomial g(x) of degree n of Galois field is set, except for a coefficient of the highest degree n, to said first and second registers, and
said inner product calculation part outputs a CRC code corresponding to a modulus (mod) of the polynomial g(x) for the data set in said third register.

5. The code computing apparatus according to claim 2, wherein
said matrix element computation part generates matrix elements for encryption, and
said inner product calculation part outputs an encryption code of the data set in said third register.

6. The code computing apparatus according to claim 5, further comprising:
a first memory for storing coefficient data of an irreducible polynomial g(x) of degree n of Galois field and encryption key data;
a control part (70) for reading out from said memory the coefficient data and the encryption key data in a form divided into a plurality of data blocks and setting them in said first and second registers, respectively, and
a second memory for storing elements values of a plurality of partial matrices, wherein
elements of a plurality of partial of matrix of n×n are generated by said matrix element computation part (30), and
under the control of said control part, the elements of partial matrix generated by said matrix element computation part are stored in said second memory, the elements of partial matrix are selectively loaded from said second memory to said matrix element register (51), and said inner product calculation part repeats the inner product calculation between the data set in said third register and the elements of a plurality of partial matrices, thereby to output said encryption code.

7. The code computing apparatus according to claim 6, further comprising:
means (52 and 53) for performing exclusive OR operation between the results of inner product calculation generated by said inner product calculation part and pre-computed elements held as intermediate results of the calculation, and holding the results of exclusive OR operation as new intermediate results of the calculation.
